(19) United States
(12) Patent Application Publication
(10) Pub. No.: US 2004/0085444 A1
(43) Pub. Date: May 6, 2004

(54) Image capturing apparatus having a camera unit controlled by two motors for wide area coverage

(75) Inventor: Jeffreyn Ho, Jubei City (TW)

Correspondence Address: LOWE HAUPTMAN GILMAN & BERNER LLP, Suite 310, 1700 Diagonal Road, Alexandria, VA, 22314, US

(73) Assignee: PHOTIC ELECTRONICS CO., LTD

(21) Appl. No.: 10/285,565

(22) Filed: Nov. 1, 2002

(51) Int. Cl. H04N 7/18

(52) U.S. Cl. 348/143

(57) ABSTRACT

An image capturing apparatus includes camera, control and display modules. The camera module includes a camera unit adapted to generate an image output, a first motor coupled to the camera unit for controlling movement of the camera unit in a first direction, and a second motor coupled to the camera unit for controlling movement of the camera unit in a second direction transverse to the first direction. The control module is coupled electrically to the camera module, and controls operation of the first and second motors and image capturing operation of the camera unit. The display module is coupled electrically to the camera unit for receiving the image output and for displaying images corresponding to the image output thereon.

### BACKGROUND OF THE INVENTION

1. Field of the Invention

The invention relates to an image capturing apparatus for vehicle use, more particularly to an image capturing apparatus having a camera unit controlled by two motors for wide area coverage.

2. Description of the Related Art

Numerous car accessories, such as image capturing apparatus for use in car backing, car-backing radars, electric rearview mirrors, navigation systems, etc., are available in the market for enhancing driving safety.

When a driver backs a car, there are many factors, such as narrow field of vision, obstructions to the line of sight, etc., that can result in accidents. An image capturing apparatus is generally used in car backing to promote driving safety. Referring to FIG. 1, a conventional image capturing apparatus 1 is shown to comprise a camera unit 11 mounted on the rear part of a vehicle for capturing images that are transmitted to a display unit 12 in a passenger room of the vehicle so that the driver can be assisted when backing the vehicle.

The aforesaid conventional image capturing apparatus 1 suffers from the drawback of not being able to provide sufficient area coverage. Particularly, the conventional camera unit 11 relies on only one motor for pivoting movement about a single axis, i.e., the camera unit 11 is movable only in a horizontal direction so that the visual angle merely covers a 90-degree range at the rear part of the vehicle. As such, dead corners are unavoidable. Although adjustments to the mounting location of the image capturing apparatus can result in some improvement, it will not be sufficient to eliminate the presence of dead corners. Moreover, the mounting location of a conventional image capturing apparatus varies in accordance with different types of vehicles, thus resulting in inconvenience during installation.

### SUMMARY OF THE INVENTION

Therefore, the main object of the present invention is to provide an image capturing apparatus that is capable of overcoming the aforesaid drawbacks associated with the prior art.

Accordingly, the image capturing apparatus of this invention is adapted for vehicle use and includes:

a camera module adapted to be mounted on a vehicle, the camera module including a camera unit adapted to generate an image output corresponding to a surrounding environment of the vehicle, a first motor coupled to the camera unit for controlling movement of the camera unit in a first direction, and a second motor coupled to the camera unit for controlling movement of the camera unit in a second direction transverse to the first direction;

a control module coupled electrically to the camera module for controlling operation of the first and second motors and for controlling image capturing operation of the camera unit; and

a display module coupled electrically to the camera unit for receiving the image output and for displaying images of the surrounding environment of the vehicle thereon.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a conventional image capturing apparatus for use in car backing;

FIG. 2 is a schematic circuit block diagram of the preferred embodiment of an image capturing apparatus according to the present invention;

FIG. 3 is a schematic circuit block diagram illustrating a user input unit and a signal converter of a control module of the preferred embodiment;

FIG. 4 is a schematic diagram illustrating how a camera module of the preferred embodiment is mounted on a vehicle;

FIG. 5 is a schematic electrical circuit diagram illustrating a position sensor set and motor driving circuits of the preferred embodiment;

FIG. 6 is an exploded perspective view of the camera module of the preferred embodiment;

FIG. 7 is an assembled perspective view of the camera module of the preferred embodiment;

FIG. 8 is a schematic view illustrating the pivoting movement of a camera unit of the camera module in a first direction;

FIG. 9 is a schematic view illustrating the pivoting movement of the camera unit of the camera module in a second direction;

FIG. 10 is a perspective view of the user input unit of the preferred embodiment;

FIG. 11 is a schematic electrical circuit diagram of the user input unit of the preferred embodiment;

FIG. 12 is a schematic diagram illustrating how the user input unit, the signal converter and a display module of the preferred embodiment are mounted in a passenger room of a vehicle; and

FIG. 13 is a schematic electrical circuit diagram of the signal converter of the preferred embodiment.

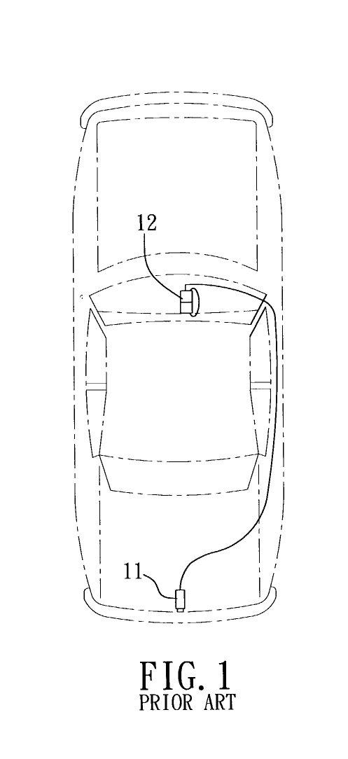

### DETAILED DESCRIPTION OF THE PREFERRED EMBODIMENT

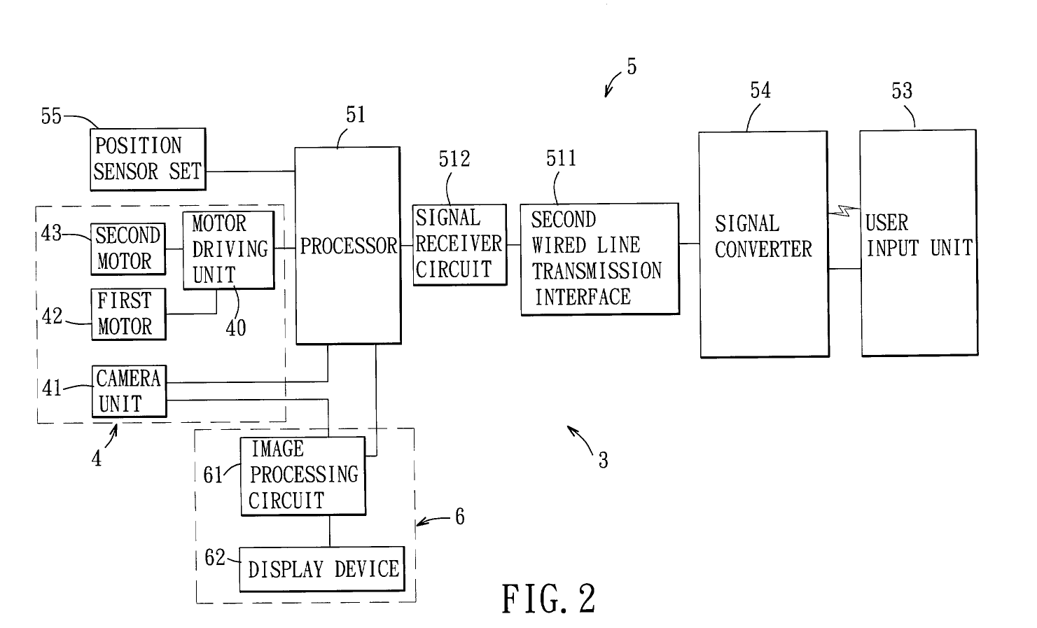

Referring to FIG. 2, the preferred embodiment of an image capturing apparatus 3 according to the present invention is shown to comprise a camera module 4, a control module 5, and a display module 6.

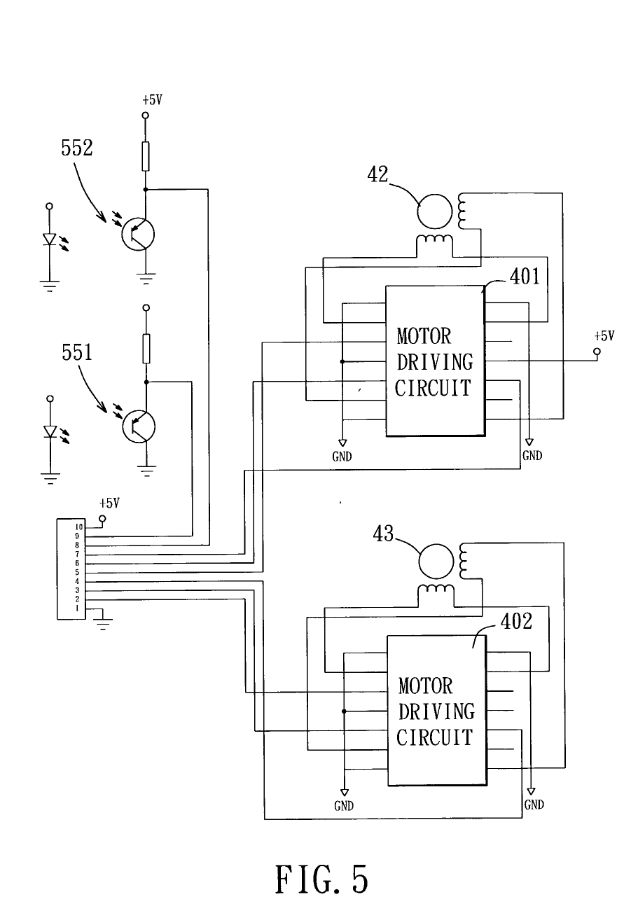

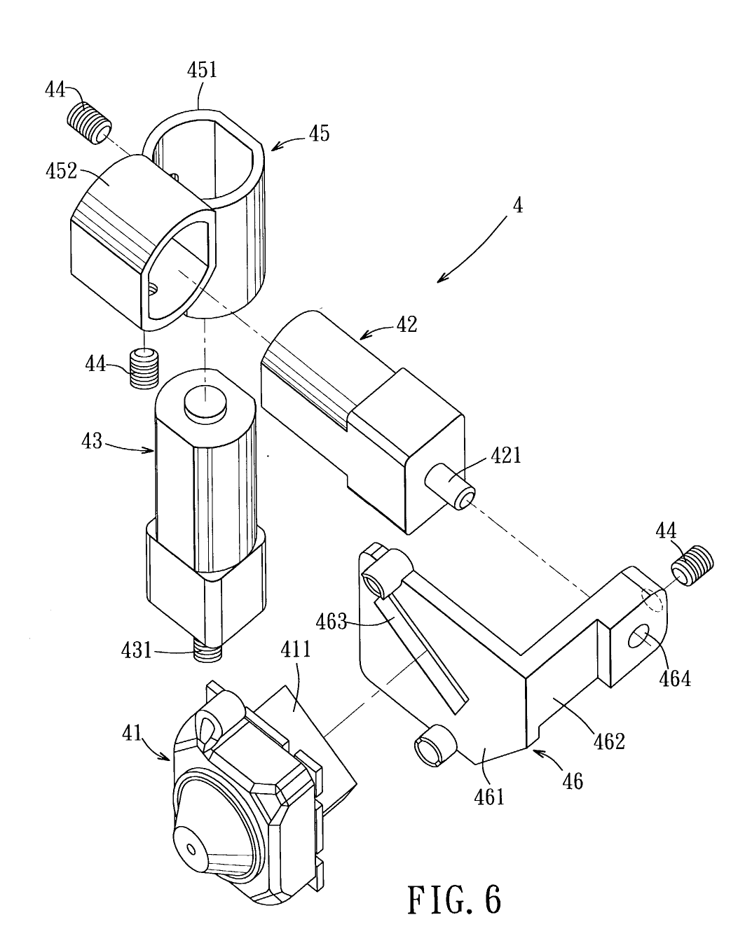

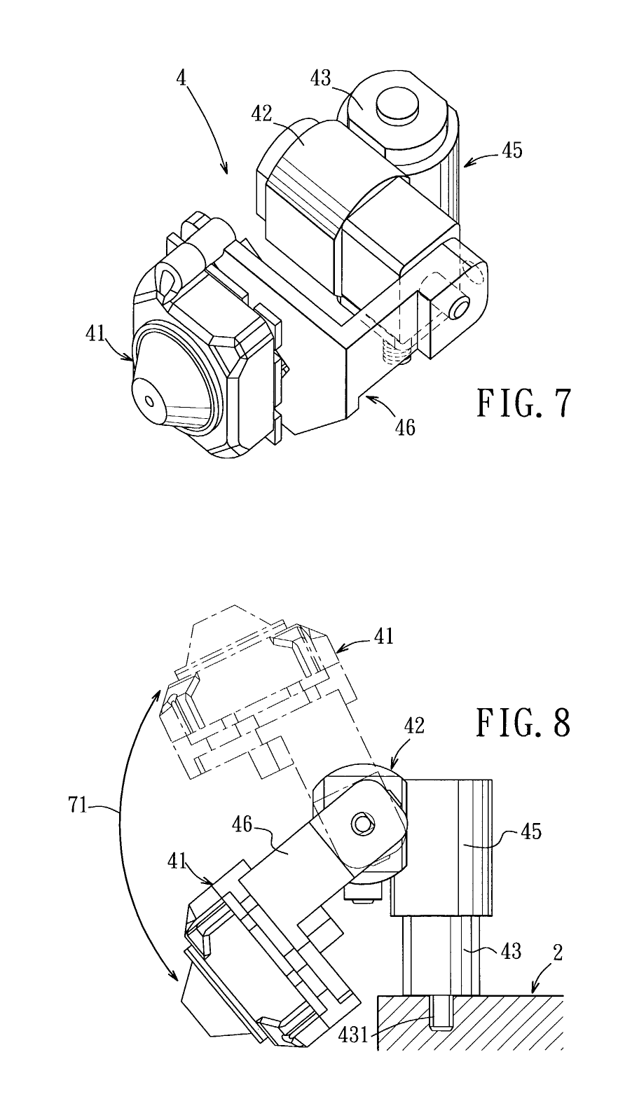

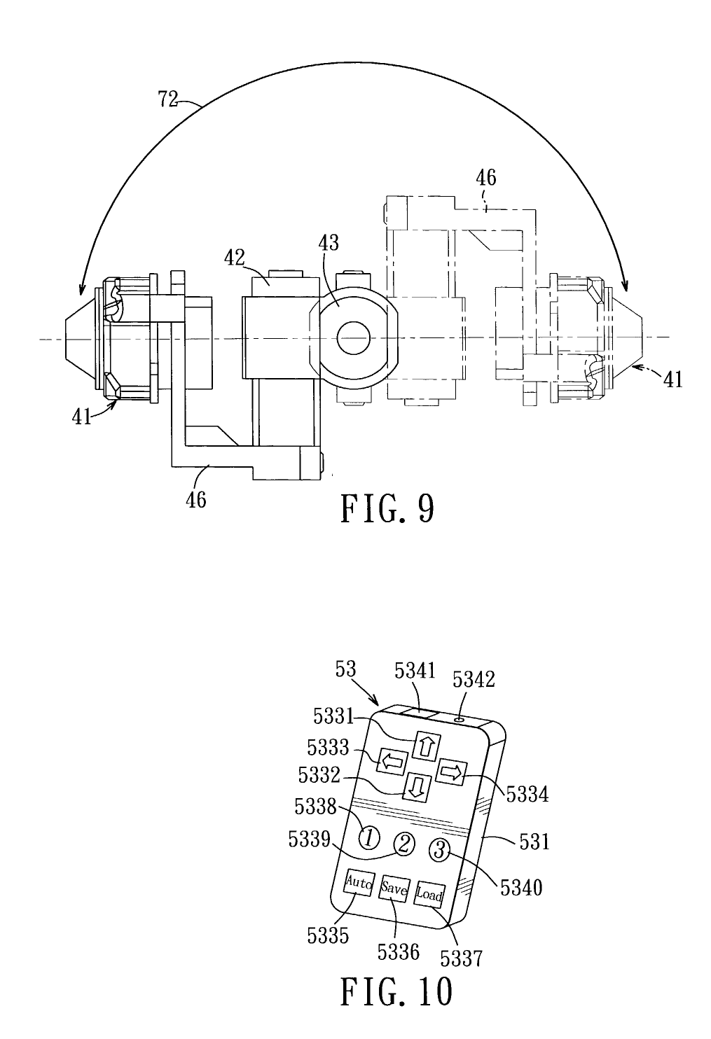

The camera module 4 is adapted to be mounted on any desired location of a vehicle, and includes a camera unit 41 for generating an image output corresponding to a surrounding environment of the vehicle, a first motor 42 to control movement of the camera unit 41 in a first direction, and a second motor 43 to control movement of the camera unit 41 in a second direction transverse to the first direction. As shown in FIG. 4, the camera module 4 is mounted on a rear bumper 21 of a vehicle 2 in this embodiment, and the first direction 71 is a vertical direction, whereas the second direction 72 is a horizontal direction. The camera unit 41 is a conventional charge coupled device (CCD) camera. In order to control the motors 42, 42, the camera module 4 further includes a motor driving unit 40 coupled electrically to the first and second motors 42, 43. As shown in FIG. 5, the motor driving unit 40 includes a pair of known motor driving circuits 401, 402 coupled electrically to and controlling operation of the first and second motors 42, 43, respectively. Furthermore, as shown in FIG. 6, to permit positioning of the camera unit 41 and the first and second motors 42, 43, the camera module 4 of this embodiment further includes a motor sleeve 45 and a camera mounting member 46. The motor sleeve 45 includes a first sleeve portion 452 sleeved on the first motor 42, and a second sleeve portion 451 sleeved on the second motor 43. The second sleeve portion 451 extends in a direction transverse to the first sleeve portion 452. The camera mounting member 46 includes a first end 462 coupled to the first motor 42, and a second end 461 transverse to the first end 462 and formed with a camera-mounting groove 463. The first motor 42 has a motor shaft 421, and the first end 462 is formed with a through hole 464 for receiving the motor shaft 421. The camera unit 41 has a camera-mounting block 411 received in the camera-mounting groove 463. With further reference to FIG. 7, during assembly, the first and second motors 42, 42 are sleeved in the first and second sleeve portions 452, 451, and are secured thereon by a pair of fasteners 44, respectively. The camera-mounting block 411 engages the camera-mounting groove 463, and the motor shaft 421 of the first motor 42 is retained in the through hole 464 in the first end 462 with the use of a fastener 44. Referring to FIG. 8, after assembly, by virtue of the control module 5, the first motor 42 can cause the camera unit 41 to pivot in the first direction 71 within a 180-degree range, i.e., 90-degrees up and 90-degrees down relative to a horizontal plane. Referring to FIG. 9, by virtue of the control module 5, and because the second motor 43 has a motor shaft 431 secured to the vehicle 2 (see FIG. 8), the second motor 43 can cause the camera unit 41 to pivot in the second direction 72 within a 180-degree range, i.e., 90 degrees left and 90-degrees right relative to a vertical plane transverse to the length of the rear bumper 21. It should be noted that, although the first and second motors 42, 43 can be configured to pivot the camera unit 41 in the respective one of the first and second directions 71, 72 within a 360-degree angular range, only a 180-degree range is required in actual practice due to space and practical limitations.

Referring again to FIG. 2, the control module 5 is responsible for controlling operation of the first and second motors 42, 43, and for controlling image capturing operation of the camera unit 41. The control module 5 independently controls the operations of the first and second motors 42, 43 so that the latter can be simultaneously operated to move the camera unit 41 around to achieve wide area coverage. In this embodiment, the control module 5 includes a processor 51 that is contained in a box 50, which is disposed in the rear portion of the vehicle body as best shown in FIG. 4, and that is electrically connected to the motor driving unit 40 and the camera unit 41. The processor 51 is a microprocessor chip that provides the functions of processing and storage of signals, and that drives the motor driving unit 40 and the camera unit 41 according to input control commands or system default conditions.

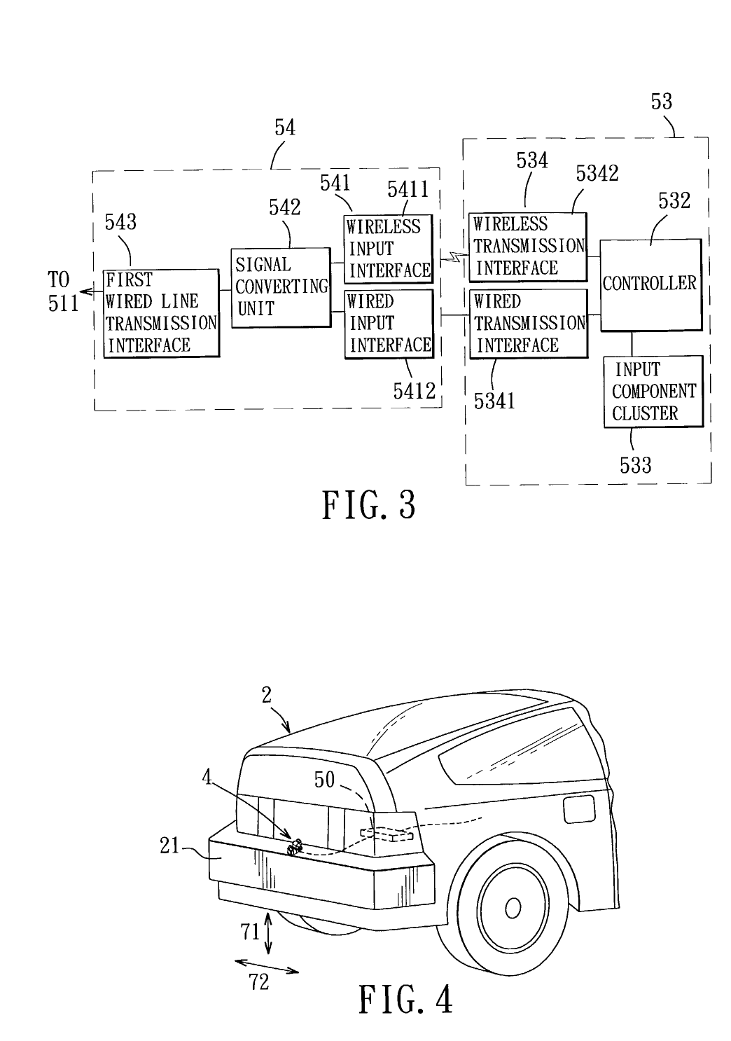

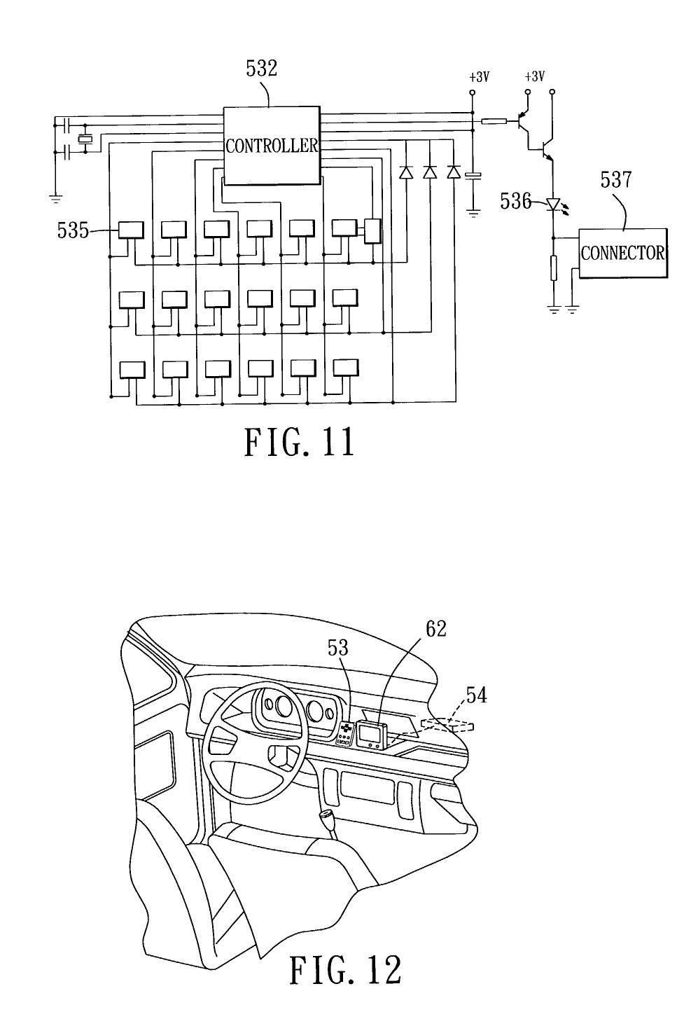

Moreover, the control module 5 further includes a user input unit 53 coupled electrically to the processor 51 and operable so as to provide the input control commands to the processor 51. As shown in FIGS. 3 and 10, the user input unit 53 includes a hand held rectangular shell body 531, a controller 532, an input component cluster 533, and an output interface unit 534. The controller 532 is disposed inside the rectangular shell body 531. The input component cluster 533 includes a direction keypad set comprising up, down, left and right direction keys 5331-5334, an automatic adjust (AUTO) key 5335, a save key 5336, a load key 5337, and three memory keys 5338-5340. It should be noted that the actual number of memory keys can be adjusted as required. As shown in FIG. 11, the controller 532 is an integrated circuit coupled electrically to a switch set 535 which is associated with the input component cluster 533. The controller 532 is configured with a table of control codes that correspond to the keys 5331-5340, and is operable so as to encode control commands. When one of the keys 5331-5340 is depressed, the corresponding switch in the switch set 535 will be closed. The controller 532 is thus able to determine which key 5331-5340 was operated in view of the change in state of the corresponding switch, and responds by generating an encoded control command with reference to the table of control codes. The encoded control command is then transmitted to the output interface unit 534. The output interface unit 534 is coupled electrically to the controller 532 and the processor 51 for transmitting the encoded control command from the controller 532 to the processor 51. In this embodiment, the output interface unit 534 includes a wired transmission interface 5341 and a wireless transmission interface 5342. As shown in FIG. 11, the wireless transmission interface 5342 includes a light-emitting diode 536 for converting electrical signals into light signals for wireless transmission. In alternative embodiments, the wireless transmission interface 5342 can be implemented using a radio frequency transmitter, a Bluetooth wireless transmitter, etc. The wired transmission interface 5341 includes a connector 537 for connecting with a cable to permit signal transmission to the processor 51.

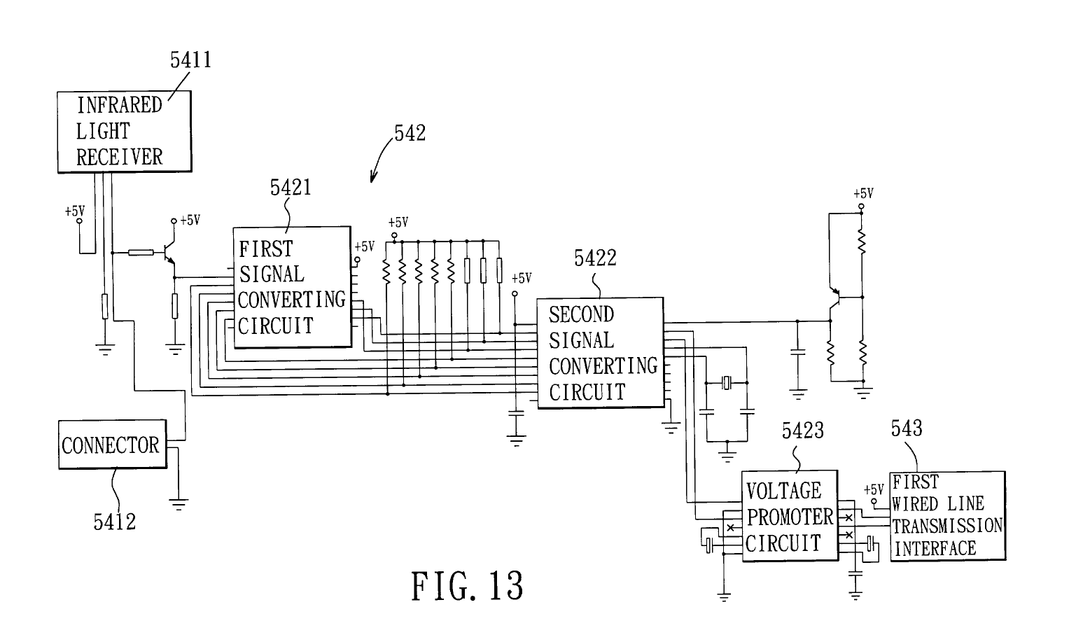

Furthermore, when the vehicle 2 is in motion, operation of vehicle components can interfere with signals from the user input unit 53, especially when wireless transmission is in use. Such interference can result in errors in signals received by the processor 51. To minimize signal interference, the control module 5 further includes a signal converter 54 coupled electrically to the processor 51 and the user input unit 53 for ensuring integrity of the control commands from the user input unit 53. Since signals can be protected from interference when transmitted through a shielded route, in this embodiment, the signal converter 54 is disposed at the vicinity of the user input unit 53, which is near the driver's seat inside the passenger room of the vehicle, as best shown in FIG. 12. As shown in FIG. 3, the signal converter 54 includes an input interface unit 541, a signal converting unit 542, and a first wired line transmission interface 543. The input interface unit 541 is coupled electrically to the output interface unit 534 and has a compatible interface specification for receiving the encoded control commands from the output interface unit 541. As shown in FIG. 13, the input interface unit 541 includes a wireless input interface 5411, such as an infrared light receiver, and a wired input interface 5422, such as a cable connector. In order to convert signals from the user input unit 53 into those suitable for wired transmission media, the signal converting unit 542 includes a first signal converting circuit 5421 for converting infrared signals to input digital signals, and a second signal converting circuit 5422 for converting the input digital signals to those suitable for reception by the processor 51 through the first wired line transmission interface 543. Moreover, in order to minimize the effect of signal attenuation due to long-distance transmission, the signal converting unit 542 further includes a voltage promoter circuit 5423 electrically coupled between the second signal converting circuit 5422 and the first wired line transmission interface 543 for promoting potential value of the encoded control commands outputted from the second signal converting circuit 5422 (for example, 5V is promoted to 12V). As such, even if signals are weakened during transmission, through the increase in potential value attributed to the voltage promoter circuit 5423, the weakened signals can still be correctly detected by the processor 51 for accurate processing.

Referring once again to FIGS. 2, 3 and 4, the box 50 containing the processor 51 further has a second wired line transmission interface 511 corresponding to the first wired line transmission interface 543, and a signal receiver circuit 512 coupled electrically to the processor 51 and the second wired line transmission interface 511. The signal receiver circuit 512 adjusts the potential value of the encoded control commands that are to be provided to the processor 51, such as by potential conversion, wave rectification, etc. Moreover, in order to determine whether the first and second motors 42, 43 have moved the camera unit 41 to a desired position, the control module 5 further includes a position sensor set 55 coupled electrically to the processor 51 and operably associated with the first and second motors 42, 43 for generating motor position signals that are provided to the processor 51. As shown in FIG. 5, the position sensor set 55 includes a pair of photo-sensors 552, 551 for sensing the rotations of the first and second motors 42, 43, respectively. Based on the motor position signals, the processor 51 is able to control the first and second motors 42, 43 until the camera unit 41 is properly positioned.

The display module 6 is coupled electrically to the camera unit 41, receives the image output, and displays images of the surrounding environment of the vehicle 2 thereon. The display module 6 includes an image processing circuit 61 and a display device 62, such as a liquid crystal display device, coupled to the image processing circuit 61. The image processing circuit 61 is a known integrated circuit electrically connected to the processor 51 and the camera unit 41, and is also disposed in the box 50 (see FIG. 4). The image processing circuit 61 processes and converts image data from the camera unit 41 to enable the display device 62 to show the corresponding images thereon.

Based on the foregoing, when the user inputs a control command through the user input unit 53, the controller 532 will encode the control command for subsequent output through the output interface unit 534 using either wired or wireless transmission. Then, upon receiving the encoded control command, the signal converter 54 will convert the control command into signals suitable for reception by the processor 51, and promote the potential value thereof for transmission to the processor 51 through the first wired line transmission interface 543, the second wired line transmission interface 511, and the signal receiver circuit 512. After signal adjustment by the signal receiver circuit 512, the processor 51 will, in response to the control command, control the motor driving unit 40 to drive the first and second motors 42, 43 accordingly for moving the camera unit 41 to the intended position.

The function of each key 5331-5340 in the input component cluster 533 is described as follows:

When any one of the keys 5331-5334 in the direction keypad set is depressed, a corresponding command code from the controller 532 will be generated and outputted to the processor 51 through the output interface unit 534, the signal converter 54, the second wired line transmission interface 511 and the signal receiver circuit 512. As mentioned hereinabove, the controller 532 is configured with a table of command codes that correspond respectively to the keys 5331-5340. As such, when the up key 5331 is depressed, the processor 51 will control the motor driving unit 40 to drive the first motor 42 to pivot the camera unit 41 upwardly in the first direction 71 so that the camera unit 41 can capture images at a higher viewing angle. When the down key 5332 is depressed, the processor 51 will control the motor driving unit 40 to drive the first motor 42 to pivot the camera unit 41 downwardly in the first direction 71 so that the camera unit 41 can capture images at a lower viewing angle. On the other hand, when the left key 5333 or the right key 5334 is depressed, the processor 51 will control the motor driving unit 40 to drive the second motor 42 to pivot the camera unit 41 leftward or rightward in the second direction 72. Furthermore, since the first and second motors 42, 43 can be independently controlled by the processor 51, when the up key 5331 and any one of the left and right keys 5333, 5334, or the down key 5332 and any one of the left and right keys 5333, 5334 are simultaneously depressed, the processor 51 will simultaneously control the operations of the first and second motors 42, 43 accordingly to solve the problem of dead corners commonly encountered in the prior art.

As described in the foregoing, when the first and second motors 42, 43 are in operation, the position sensor set 55 will generate corresponding motor position signals that are provided to the processor 51 so as to enable the latter to determine the actual position of the camera unit 411 at any time. Since the processor 51 is provided with memory for storage of information, the position information can be stored for subsequent use.

The AUTO key 5335 corresponds to a default position of the camera unit 41 set by the user or manufacturer. In other words, the processor 51 has a set of default position values for the first and second motors 42, 43 stored therein. Therefore, when the user operates the AUTO key 5335, the processor 51 will control the motor driving unit 40 to drive the first and second motors 42, 43 for moving the camera unit 41 to the default position. As such, movement of the camera unit 41 to the default position is thus facilitated.

Moreover, the desired position of the camera unit 41 may vary among drivers and among different driving conditions. For this reason, this embodiment provides a memory function for customizing the position of the camera unit 41. Particularly, after the position of the camera unit 41 has been adjusted through the direction keypad set, the save key 5336 and one of the memory keys 5338-5340 can be operated to store the desired camera setting derived from the motor position signals. In this embodiment, the three memory keys 5338-5340 cooperate with the save key 5336 to permit storage of up to three camera settings.

Subsequently, when it is desired to move the camera unit 41 to one of the predefined camera settings, the load key 5337 and a selected one of the memory keys 5338-5340 can be operated to enable the processor 51 to control operation of the first and second motors 42, 43 accordingly.

Some of the advantages of this invention are as follows:

1. The camera unit 41 can be moved for wide area coverage. As compared to the conventional image capturing apparatus that allows a camera unit to move in only a horizontal or vertical direction, the camera module 4 of this invention includes a pair of motors 42, 43 that can be independently controlled to move the camera unit 41 in two different directions 71, 72. Thus, wide area coverage is possible in the present invention to minimize the presence of dead corners.

2. The camera unit 41 can be easily moved to a default position or a predefined camera setting by merely operating one or two keys of the user input unit 53. Moreover, the user input unit 53 can transmit control commands in either a wired or wireless manner such that the mounting location thereof is rather flexible. In other words, the user input unit 53 can be located for easy access and operation by the user.

It should be noted that although the camera module 4 in this embodiment is mounted on the rear bumper of a vehicle, in actual use, there are no restrictions as to the mounting of the camera module 4. For example, the camera module 4 can be mounted on a roof of a vehicle body or can be integrated with a rearview mirror, and should not be limited to that disclosed herein.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An image capturing apparatus for a vehicle, comprising:
a camera module adapted to be mounted on the vehicle, said camera module including a camera unit adapted to generate an image output corresponding to a surrounding environment of the vehicle, a first motor coupled to said camera unit for controlling movement of said camera unit in a first direction, and a second motor coupled to said camera unit for controlling movement of said camera unit in a second direction transverse to the first direction;
a control module coupled electrically to said camera module for controlling operation of said first and second motors and for controlling image capturing operation of said camera unit; and
a display module coupled electrically to said camera unit for receiving the image output and for displaying images of the surrounding environment of the vehicle thereon.

2. The image capturing apparatus as claimed in claim 1, wherein said first motor controls pivoting movement of said camera unit in the first direction within a first angular range.

3. The image capturing apparatus as claimed in claim 2, wherein the first angular range is a 180-degree range.

4. The image capturing apparatus as claimed in claim 1, wherein said second motor controls pivoting movement of said camera unit in the second direction within a second angular range.

5. The image capturing apparatus as claimed in claim 4, wherein the second angular range is a 180-degree range.

6. The image capturing apparatus as claimed in claim 1, wherein said camera module further includes a motor driving unit coupled electrically to said first and second motors, said motor driving unit being coupled electrically to and being controlled by said control module for generating motor control signals to control operation of said first and second motors.

7. The image capturing apparatus as claimed in claim 6, wherein said motor driving unit includes a pair of motor driving circuits coupled electrically to said control module and controlling operation of said first and second motors, respectively.

8. The image capturing apparatus as claimed in claim 1, wherein said control module includes a processor for controlling the image capturing operation of said camera unit.

9. The image capturing apparatus as claimed in claim 8, wherein said control module further includes a user input unit coupled electrically to said processor and operable so as to provide control commands to said processor.

10. The image capturing apparatus as claimed in claim 9, wherein said user input unit includes:
an input component cluster operable so as to generate the control commands;
a controller coupled electrically to said input component cluster and operable so as to encode the control commands; and
an output interface unit coupled electrically to said controller and said processor for transmitting encoded control commands from said controller to said processor.

11. The image capturing apparatus as claimed in claim 10, wherein said output interface unit includes a wired transmission interface.

12. The image capturing apparatus as claimed in claim 10, wherein said output interface unit includes a wireless transmission interface.

13. The image capturing apparatus as claimed in claim 10, wherein said input component cluster includes a direction key pad set operable so as to generate direction control commands for controlling direction of movement of said camera unit.

14. The image capturing apparatus as claimed in claim 13, wherein said control module further includes a position sensor set coupled electrically to said processor and operably associated with said first and second motors for generating motor position signals that are provided to said processor.

15. The image capturing apparatus as claimed in claim 14, wherein said input component cluster further includes a save key, a load key, and a plurality of memory keys,
operation of said save key and one of said memory keys enabling said processor to store a desired camera setting derived from the motor position signals,
operation of said load key and one of said memory keys enabling said processor to control operation of said first and second motors according to a selected camera setting.

16. The image capturing apparatus as claimed in claim 10, wherein said control module further includes a signal converter coupled electrically to said processor and said user input unit for ensuring integrity of the control commands from said user input unit.

17. The image capturing apparatus as claimed in claim 16, wherein said signal converter includes:
an input interface unit coupled electrically to said output interface unit for receiving the encoded control commands;
a signal converting unit coupled electrically to said input interface unit for processing the encoded control commands into a form suitable for reception by said processor; and
a first wired line transmission interface coupling electrically said signal converting unit to said processor.

18. The image capturing apparatus as claimed in claim 17, wherein said control module further includes a second wired line transmission interface coupling electrically said first wired line transmission interface to said processor.

19. The image capturing apparatus as claimed in claim 18, wherein said signal converting unit includes a voltage promoter circuit for promoting potential value of the encoded control commands.

20. The image capturing apparatus as claimed in claim 19, wherein said control module further includes a signal receiver circuit coupled electrically to said processor and said second wired line transmission interface for adjusting the potential value of the encoded control commands that are to be provided to said processor.

21. The image capturing apparatus as claimed in claim 1, wherein said camera module further includes:
a motor sleeve having a first sleeve portion sleeved on said first motor, and a second sleeve portion sleeved on said second motor, said second sleeve portion extending in a direction transverse to said first sleeve portion; and
a camera mounting member having a first end coupled to said first motor, and a second end, said camera unit being mounted on said second end of said camera mounting member.
